(19) United States
(12) Patent Application Publication
(10) Pub. No.: US 2020/0051450 A1
(43) Pub. Date: Feb. 13, 2020

(54) AUDIO-VISUAL TEACHING PLATFORM AND RECOMMENDATION SUBSYSTEM, ANALYSIS SUBSYSTEM, RECOMMENDATION METHOD, ANALYSIS METHOD THEREOF

(71) Applicant: Facil Ltd.Co., Taipei City (TW)

(72) Inventors: PING-CHENG YEH, Taipei City (TW); YAO-HSIN CHENG, Taipei City (TW); JIA-LIANG GUO, Taipei City (TW); CHING-CHANG CHOU, Taipei City (TW)

(21) Appl. No.: 16/535,981

(22) Filed: Aug. 8, 2019

Related U.S. Application Data
(60) Provisional application No. 62/718,207, filed on Aug. 13, 2018.

(51) Int. Cl. G09B 7/00; G06K 9/00; G10L 25/90

(52) U.S. Cl. CPC G09B 7/00; G10L 25/90; G06K 9/00718

(57) ABSTRACT

The invention provides an audio-visual teaching platform, which includes an analysis subsystem, a recommendation subsystem and a training subsystem. The analysis subsystem provides a learning behavior data to enable the recommendation subsystem to generate at least one presumptive learning mode by using the learning behavior data, thereby generating a recommended learning combination. When the training subsystem receives the recommended learning combination, the training subsystem transmits an audio-visual knowledge content which is set to a user for watching and learning. Accordingly, the invention recommends the audio-visual knowledge content to the users with the same or similar presumptive learning mode, and analyzes the interaction between the users and the audio-visual knowledge content, so as to enable the users to really watch the audio-visual knowledge content and enhance their interest in learning.

### CROSS REFERENCE TO RELATED APPLICATIONS

The present application is based on a provisional application Ser. No. 62/718,207 filed on Aug. 13, 2018 which is hereby incorporated by reference.

### BACKGROUND OF THE INVENTION

### 1. Field of the Invention

The invention relates to an audio-visual teaching platform, particularly to achieve the recommendation and adaptability evaluation of learning information by collecting interactive information of users, and to analyze the interactive audio-visual teaching platform between users and audio-visual knowledge content.

### 2. Description of the Prior Art

With the development of network and personal electronic equipment, the old teaching methods such as after-class school or tutor have been gradually replaced by multimedia teaching. Among them, in the field of individual learning or enterprise education and training, online multimedia teaching is not limited to fixed teaching time and fixed teaching location, can stop at any time, replay, fast forward and other characteristics are also the main reasons for its popularity.

Current multimedia teaching often transmits learning information of course-related audio-visual knowledge content from the teaching system end to the user end. However, it is hard to measure or get feedback on the real participation and learning effectiveness of the users, nor to adjust learning content properly by the learning levels of the users, resulting in one-way learning information transmission.

Further when the enterprise uploads the audio-visual knowledge content independently by the internal staff and chooses the appropriate audio-visual knowledge content therein to make a course for education and training. This practice will produce excessive fragmentary audio-visual knowledge content, which not only needs a lot of manpower to organize, but also is difficult to link with the audio-visual knowledge content of formal and systematic education and training, resulting in the bewildered dilemma of trainees in enterprises.

Although there are some data such as the number of times and hours of playing learning information as a measure of learning effectiveness, it is still unable to get feedback from the users and further adjust the learning content appropriately. Take the education and training of enterprises as an example, the users usually use idle computers to broadcast learning information to lengthen the watching hours, but they do not really participate in learning or make a response to learning behavior.

In addition, the learning effectiveness and measurement of learning information have different meanings of user interaction in different fields, types and even different lecturers. Therefore, there must be a weighted measurement of the evaluation method.

Thus, how to make use of historical learning records and collect and analyze feedback information of the users in the learning process to integrate various sources of the audio-visual knowledge content, including formal education and training content, external digital platform knowledge content, and internal users upload knowledge content for planning the optimum curriculum structure, and to further carry on recommending and assessing the adaptability of the learning information based on this framework has become the focus that all walks of life want to improve urgently.

### SUMMARY OF THE INVENTION

In view of the problems described in the previous techniques, one of the purposes of the present invention is to provide an audio-visual teaching platform by which an analysis subsystem can provide a learning behavior data so that the recommendation subsystem can use the learning behavior data to generate at least one presumptive learning mode, thereby generating a recommended learning combination. In this way, when the training subsystem receives the recommended learning combination, it will set up the audio-visual knowledge content according to the recommended learning combination to transmit the set audio-visual knowledge content to a database for storage and transmission to a user for watching and learning.

Accordingly, the related audio-visual knowledge content is recommended to the users of the same or similar presumptive learning mode, and the interactive users between the users and the audio-visual knowledge content are analyzed, as well as the time points at which the concentration of the users in the learning process decreases and improves, so that the users can really watch the audio-visual knowledge content and enhance their interest in learning.

In view of the problems described in the previous technology, another purpose of the present invention is to use the historical learning records of the users and collect and analyze feedback information in the learning process to achieve the adaptability evaluation of learning information.

Another purpose of the present invention is to provide an analysis method of an audio-visual teaching platform, which mainly includes user-defined interactive element, user analysis module, audio-visual content analysis module, message analysis module, time-sequential interactive module and integrated multi-sequence analysis module.

The user-defined interactive element is set on an audio-visual knowledge content interface and contains interactive factors, such as asking questions, answering questions, taking notes, marking key points, emoticons, fast forward and rewind, each of the interactive factors provides the input of interactive data.

The user analysis module uses plural historical learning behavior data of all users in a database to calculate a distance and clustering according to each of the plural historical learning behavior data, and categorizes the current users into their corresponding user clusters to generate the user clustering data related to clustering results.

The object in image data belonging to the audio-visual knowledge content is marked through an audio-visual content analysis module to generate the image object sequence related to each of time points in the audio-visual knowledge content, carries on an audio frequency analysis of the audio data belonging to the audio-visual knowledge content, calculates a pitch of each of audio frames, and generates the audio sequence related to each of the time points in the audio-visual knowledge content.

The message analysis module uses texts extracted from the database to carry on purpose classification for interactive data to generate the message sequence related to the purpose of the interactive data.

The time-sequential interactive module correlates the input time of the interactive data and the corresponding time points in the time axis of the audio-visual knowledge content and generates the interactive time points, and then combines each of the interactive time points in the time axis of the audio-visual knowledge content to generate the time-sequential interactive sequence.

The integrated multi-sequence analysis module generates a learning behavior data of a current user related to an interactive factor at any one of the interactive time points on the time axis of the audio-visual knowledge content by using a user clustering data, an image object sequence, an audio sequence, a message sequence and a time-sequential interactive sequence.

The user-defined interactive element further sets a weight of the interactive factors, the learning behavior data corresponding to each of user clusters and the interactive factors are generated through a correlation between the integrated multi-sequence analysis module and the user clustering data.

Another purpose of the present invention is to further provide an analysis method of an audio-visual teaching platform which comprises the steps of:

inputting an interactive data into an interactive factor on a user-defined interactive element set on an audio-visual knowledge content interface;

using user analysis module to calculate a distance and clustering of plural historical learning behavior data of all users in a database according to each of the plural historical learning behavior data, and categorizing current users into corresponding user clusters to generate a user clustering data;

marking object in an image data belonging to an audio-visual knowledge content by an audio-visual content analysis module to generate an image object sequence related to each of time points in the audio-visual knowledge content;

calculating a pitch of each of audio frames of audio data that belongs to the audio-visual knowledge content by the audio-visual content analysis module for audio frequency analysis to generate an audio sequence related to each of the time points in the audio-visual knowledge content;

extracting texts in the database, and carrying on a purpose classification of the interactive data by a message analysis module to generate a message sequence related to a purpose of the interactive data;

taking an input time of the interactive data with each of the corresponding time points in the audio-visual knowledge content to generate each of the interactive time points by a time-sequential interactive module, and combining each of the interactive time points in a time axis of the audio-visual knowledge content to generate a time-sequential interactive sequence; and

correlating the user clustering data, the image object sequence, the audio sequence, the message sequence and the time-sequential interactive sequence with the interactive data by an integrated multi-sequence analysis module to generate a learning behavior data at any one of the time points in the audio-visual knowledge content.

The invention provides a time-sequential interactive module in the analysis method of the audio-visual teaching platform, which collects each of the interactive time points on the time axis of the audio-visual knowledge content and the corresponding learning behavior data to generate a long-short term memory.

The current users are compared with the long-short term memory, wherein the current users are categorized into user clusters with similar learning styles in the long-short term memory according to the learning behavior data.

The long-short term memory is used to judge the current users that belong to the user clusters, and evaluates the concentration indicator according to the distribution of each of the interactive time points on the time axis of the user clusters in the audio-visual knowledge content and the corresponding learning behavior data of each of the interactive time points.

The long-short term memory is used to judge the current users that belong to the user clusters, and activates the interactive factor on the user-defined interactive element according to a time interval of lower concentration indicator on the time axis of the user clusters in the audio-visual knowledge content to provide input of the interactive data.

In view of the problems described in the previous techniques, the present invention further aims at exploiting the subsequent correlated audio-visual knowledge content related to the knowledge content from multiple sources in the past through experiment and validation processes by using the behavior of at least one user who has watched the plural audio-visual knowledge content from multiple sources in the past, which makes it possible to achieve recommendation of learning data and application of adaptability without need too much manpower to organize the plural audio-visual knowledge content.

A further purpose of the present invention is to provide a recommendation subsystem of an audio-visual teaching platform, which includes an exploration module, an experiment module and a verification module. The exploration module generates at least one presumptive learning mode according to a learning behavior data from which at least one user watches the plural audio-visual knowledge content from multiple sources. The experiment module generates the subsequent learning experiment combination according to the presumptive learning mode, and the verification module validates whether the subsequent learning experiment combination meets validation requirements according to one of the learning modes. When it meets the requirements, the subsequent learning experiment combination is taken as a recommended learning combination.

The steps of using the exploration module to generate at least one presumptive learning mode according to a learning behavior data of at least one user watching the plural audio-visual knowledge content from multiple sources further include: categorizing each of the plural audio-visual knowledge content into at least one knowledge cluster according to its source and learning theme, categorizing the user to each audio-visual knowledge; taking at least one learning behavior of the plural audio-visual knowledge content as a key indicator; capturing the time-sequential learning behavior sequence data of each of the at least one user in the at least one knowledge cluster, wherein the data format is the user access and interactive record of knowledge content at that time point; and using decision tree classification model to distinguish the learning behavior of the at least one user in the at least one knowledge cluster and generating learning modes; finally, calculating the key indicator of each of the learning modes and taking the output as the at least one presumptive learning mode.

A further purpose of the present invention is to provide a recommendation method of an audio-visual teaching platform which includes the following steps of:

using the exploration module to generate at least one presumptive learning mode according to the learning behavior data of the at least one user watching the plural audio-visual knowledge content from multiple sources; and using the experiment module to generate the subsequent learning experiment combination according to the presumptive learning mode; and then using the verification module validates whether the subsequent learning experiment combination meets validation requirements according to one of the learning modes. When the verification module judges that the subsequent learning experiment combination meets the requirements, the verification module takes the subsequent learning experiment combination as the recommended learning combination, and recommends it to other users with the same presumptive learning mode, so that the plural audio-visual knowledge content from multiple sources can be optimized for cohesive learning.

The recommendation subsystem of the audio-visual teaching platform further includes an optimum practice module which converts the time-sequential learning behavior sequence data and the identity information of all users to a series of variables, in which the identity information of the user includes user name, gender, age or name of affiliated unit to which the user belongs. The time-sequential learning behavior sequence data can be the user message time, message content and marked object. The optimum practice module takes each user as a node and uses the series of variables to calculate clustering distances between each user and uses this as a clustering benchmark, and classifies each user who meets thresholds of different clustering benchmarks into at least one clustering group, or the user whose average distance of one of the clustering distances is the smallest in each of the at least one clustering group is further searched as a group opinion leader of this clustering group.

Moreover, the optimum practice module further uses frequent pattern mining to calculate non-clustered user who is most in line with a browsing recommended learning mode under each of the knowledge clusters, and actively through one of the recommendation, matching, competition mechanisms, to make the non-clustered user approach one of the clustering groups.

### BRIEF DESCRIPTION OF THE DRAWINGS

FIG. 1 is a system architecture diagram of an audio-visual teaching platform of the present invention.

FIG. 2 is a system architecture diagram of an analysis subsystem of the audio-visual teaching platform of the present invention.

FIG. 3 is a schematic diagram of a user-defined interactive element of the present invention.

FIG. 4 is a flow chart of an analysis method of the audio-visual teaching platform of the present invention.

FIG. 5 is a schematic diagram of a long-short term memory of the present invention.

FIG. 6 is a schematic diagram of a concentration prediction and incentive mechanism of the present invention.

FIG. 7 is a system architecture diagram of a recommendation subsystem of the audio-visual teaching platform of the present invention.

FIG. 8 is a schematic diagram of a recommended learning combination of the present invention.

FIG. 9 is a schematic diagram of a recommendation in FIG. 8.

FIG. 10 is an action flow chart of a recommendation method of the audio-visual teaching platform of the present invention.

### DETAILED DESCRIPTION OF THE INVENTION

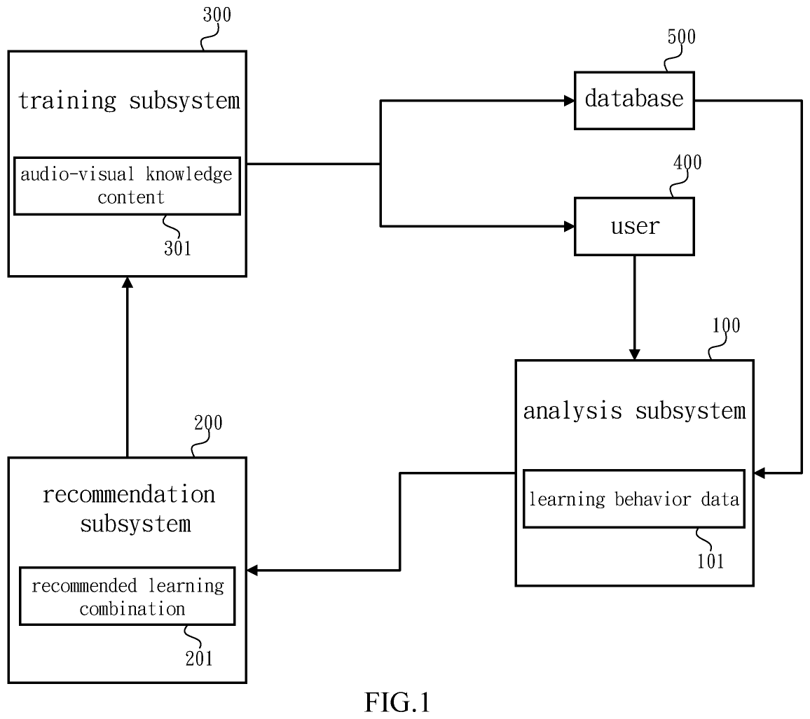

Refer to FIG. 1, which is a system architecture diagram of an audio-visual teaching platform of the invention. As shown in the figure, the audio-visual teaching platform of the invention is applied to electronic devices, such as network servers or personal computers with connecting networks (e.g., local area network or Internet).

The audio-visual teaching platform is mainly composed of analysis subsystem 100, recommendation subsystem 200 and training subsystem 300. The analysis subsystem 100 is used to analyze user clustering data, image object sequence, audio sequence, message sequence and time-sequential interactive sequence, etc. to generate learning behavior data 101 related to an interactive factor at any one of the interactive time points on a time axis of audio-visual knowledge content 301.

The recommendation subsystem 200 is connected with the analysis subsystem 100 to generate at least one presumptive learning mode according to the learning behavior data 101 of at least one user 400 watching plural audio-visual knowledge content 301 from multiple sources by the procedures of exploration, experiment and validation. Then a subsequent learning experiment combination is generated by the experiment procedures according to the presumptive learning mode. Finally, whether the subsequent learning experiment combination meets the validation requirement is verified. The subsequent learning experiment combination is taken as the recommended learning combination 201 when it meets the requirement.

The training subsystem 300 is connected with the recommendation subsystem 200 and the analysis subsystem 100. By receiving the recommended learning combination 201, each of the interactive time points within each of the plural audio-visual knowledge content 301 can be preset according to the recommended learning combination 201, and a knowledge map can be generated according to the recommended learning combination 201 to transmit each of the interactive time points and knowledge map within each of the plural audio-visual knowledge content 301 to the database 500. The training subsystem 300 provides at least one of the plural audio-visual knowledge content 301 which is preset to a user 400 to provide the at least one of the plural audio-visual knowledge content 301 to the user 400 for watching and learning.

In this way, the user 400 can carry on the actions of watching, learning and interaction through the plural audio-visual knowledge content 301 provided by the training subsystem 300. When the user 400 watches the plural audio-visual knowledge content 301, the analysis subsystem 100 and the recommendation subsystem 200 will also carry on the follow-up actions, and then learn and optimize the function of analysis and recommendation.

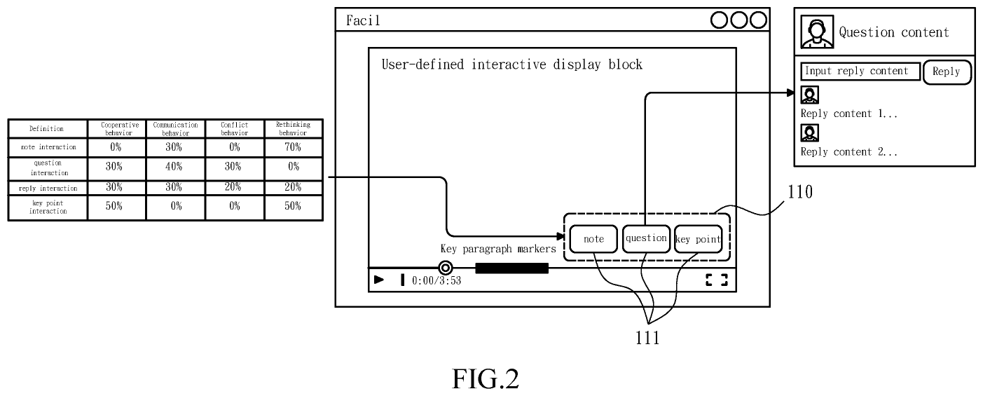

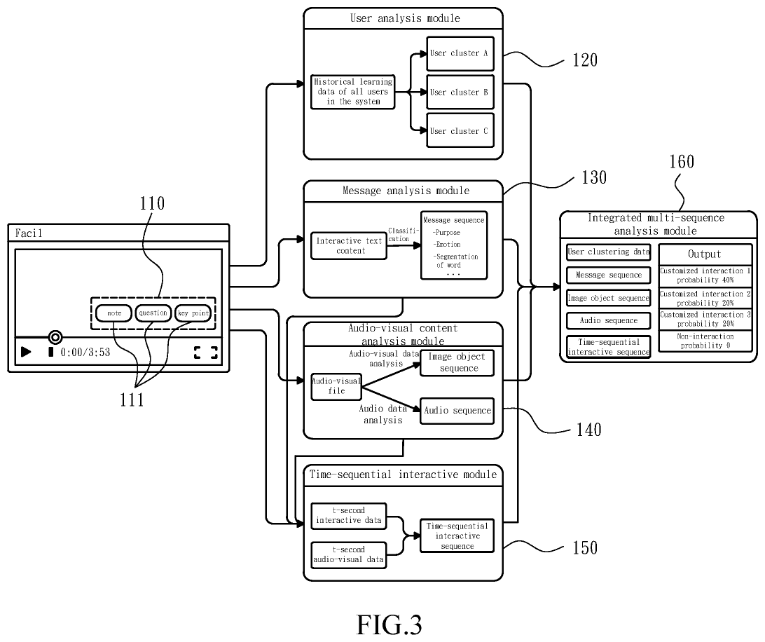

Refer to FIGS. 2 and 3, which are schematic diagrams of an analysis subsystem and a user-defined interactive element of the audio-visual teaching platform of the invention, respectively. As shown in the figures, the user-defined interactive element 110 is set in a software interface or an audio-visual knowledge content interface. The user-defined interactive element 110 has interactive factors 111 to provide input of interactive data, wherein the interactive factors 111 include asking questions, answering questions, taking notes, marking key points, emoticons, fast forward, rewind, etc. When the user opens the interactive factors 111, he can enter text content, symbols, clicks etc. in the opened dialog box or field as input of the interactive data. Among them, system administrators can adjust a weight of the interactive factors 111 and the meaning of interaction (for example, as shown in FIG. 3: cooperative behavior 30%, communication behavior 40% and conflict behavior 30%).

The analysis subsystem of the audio-visual teaching platform includes a user analysis module 120, a message analysis module 130, an audio-visual content analysis module 140, a time-sequential interactive module 150 and an integrated multi-sequence analysis module 160. These modules can be edited by programming languages and stored in electronic devices or storage media devices connected by the electronic devices (for example, network file servers, disk drives or portable disks, etc.).

The user analysis module 120 uses plural historical learning behavior data of all users in the database and data clustering techniques, such as K-means and hierarchical clustering, to calculate distance and clustering according to the plural historical learning behavior data of current users, to categorize the current users into their corresponding user clusters, and the clustering results are taken as the user clustering data, wherein the user clustering data are related to the user past learning process or the use of platform-related statistical information items, such as: question answering rate, average watching duration, number of friends and so on.

Taking K-means as an example, assuming that the two variables of question answering rate and average watching duration of the user are respectively taken as the variables of clustering, the relationship can be expressed in a two-dimensional coordinate system. Firstly, k centers are randomly selected, and the distance between each data point xⱼ and each of the centers μᵢ (using Euclidean distance) is calculated. Clustering is based on the centers nearest to each data point. Then, a new center point S is recalculated according to the clustering results. The following formula is used to iterate the above process to get a minimum value J:

$${\sum }_{i = 1}^{k} {\sum }_{{x}_{j} ∈ {S}_{i}} {( {x}_{j} - {μ}_{i} )}^{2}$$

The message analysis module 130 uses the corresponding texts extracted from the database and carries on a purpose classification based on the interactive data input by the current user, such as using an intent classification method and generating a message sequence, wherein the intent classification is based on the texts information input by the user and further judges the purpose of entering the text message. When using a long-short term memory (LSTM) after defining several categories in the database, such as airplane, train, mass rapid transit (MRT) and other types of vehicles, the most likely type of vehicle to be taken by the user is judged according to the content of the text message input by the user. For example, if the user enters “I want to go from Taiwan to Japan”, LSTM will output “airplane”. The purpose of the intent analysis is to judge the content of the message sequence, such as questions, complaints and gossip from the user.

The audio-visual content analysis module 140 marks the object in the image data that belong to the input of the plural audio-visual knowledge content, such as identifying what object is in the image data, generates the image object sequence related to each of the time points in the plural audio-visual knowledge content, and carries on an audio frequency analysis of audio data belonging to the input of the plural audio-visual knowledge content. Firstly, the whole audio data is cut into several audio frames, and then the original audio is down sampling several times by a harmonic product spectrum method. The compressed audio of the original audio after sampling is merged to highlight the high point of the fundamental frequency, calculate a pitch of each of the audio frames, eliminate unstable pitch and smoothing, and generate audio sequence related to each of the time points in the plural audio-visual knowledge content such as pitch and frequency at each of the time points.

The time-sequential interactive module 150 takes the time point when inputting the interactive data and the corresponding time point in the time axis of the plural audio-visual knowledge content when inputting the interactive data as an interactive time point, and generates a time-sequential interactive sequence that contains interactive time points.

The integrated multi-sequence analysis module 160 combines the above user clustering data, image object sequence, audio sequence, message sequence and time-sequential interactive sequence to produce a learning behavior data. From the learning behavior data, we can know the interactive results generated among the current users and the mentioned users in the user clusters and the images or sounds in the plural audio-visual knowledge content at any one of the interactive time points in the time axis of the plural audio-visual knowledge content. A long-short term memory can also be built from the distribution of the interactive time points in the time axis of the plural audio-visual knowledge content.

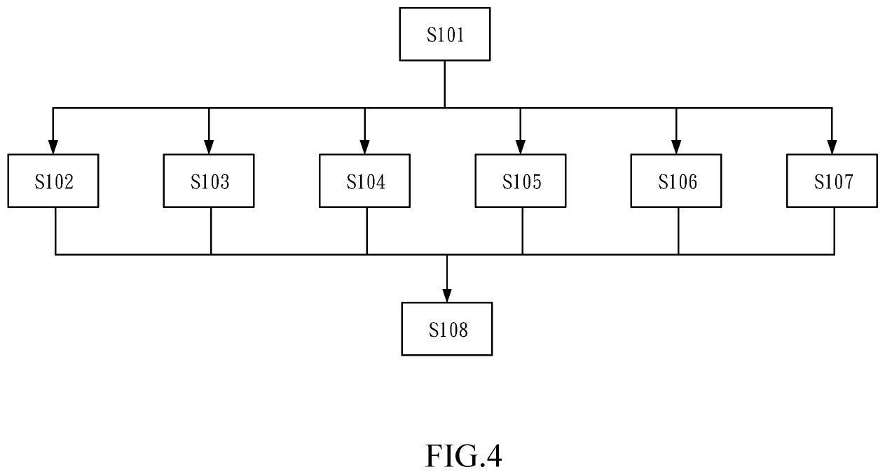

Refer to FIG. 4, which is a flow chart of an analysis method of the audio-visual teaching platform of the invention, including the following steps of:

S101: playing an audio-visual knowledge content from user, wherein a user-defined interactive element sets on an audio-visual knowledge content interface;

S102: inputting an interactive data into an interactive factor in the user-defined interactive element from the user;

S103 using user analysis module to calculate a distance and clustering of plural historical learning behavior data of all users in a database according to each of the plural historical learning behavior data, and categorizing current users into corresponding user clusters and taking this clustering result as user clustering data;

S104: marking object in an image data belonging to an audio-visual knowledge content by an audio-visual content analysis module to generate an image object sequence related to each of time points in the audio-visual knowledge content;

S105: calculating a pitch of each of audio frames of audio data that belongs to the audio-visual knowledge content by the audio-visual content analysis module for audio frequency analysis to generate an audio sequence related to each of the time points in the audio-visual knowledge content;

S106: extracting texts in the database, and carrying on a purpose classification of the interactive data by a message analysis module to generate a message sequence related to a purpose of the interactive data;

S107: taking an input time point of the interactive data with a corresponding time point on a time axis of the audio-visual knowledge content as an interactive point and collecting the interactive time points on the time axis to generate a time-sequential interactive sequence; and

S108: combining the user clustering data, the image object sequence, the audio sequence, the message sequence and the time-sequential interactive sequence by an integrated multi-sequence analysis module to generate learning behavior data corresponding to the interactive time points in the time axis of the audio-visual knowledge content.

When the user re-starts the interactive factors in the user-defined interactive element, the above steps of S102-S108 are repeated to generate the corresponding learning behavior data at the interactive time points in the time axis of the audio-visual knowledge content.

The above steps of S102-S107 are performed after receiving the interactive data input from the current user in the interactive factors, and the execution order is not subject to the limits.

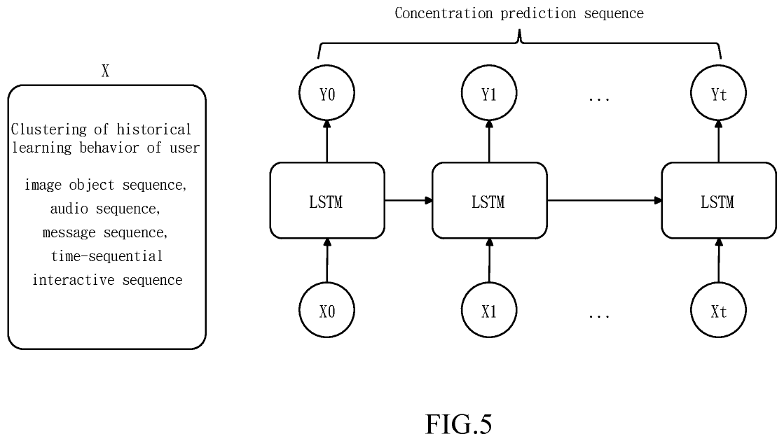

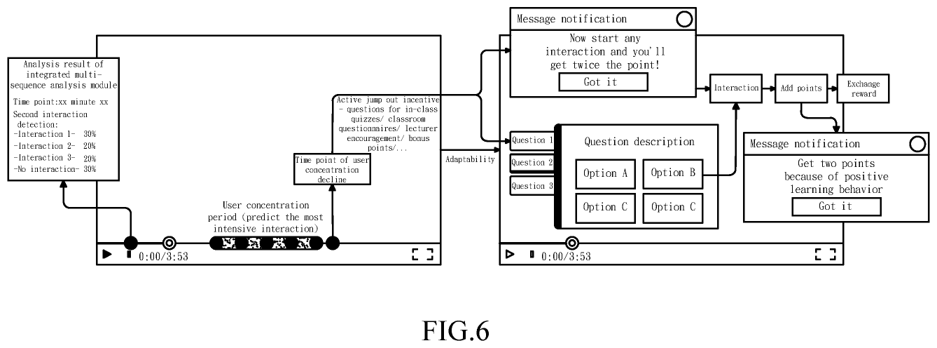

Refer to FIGS. 5 and 6, which are schematic diagrams of a long-short term memory, and a concentration prediction and incentive mechanism of the invention, respectively. As shown in the figures, the establishment and characteristics of the long-short term memory are as follows:

The schematic diagram for establishing the long-short term memory:

The time-sequential interactive module collects the interactive time points on the time axis of the audio-visual knowledge content and the corresponding learning behavior data and builds a long-short term memory. In other words, user clustering data, image object sequence, audio sequence, message sequence and time-sequential interactive sequence are used as input parameters to establish a long-short term memory that can achieve self-learning, concentration assessment and adaptability.

Self-learning of the long-short term memory:

The long-short term memory compares the learning behavior data input by the current users with the long-short term memory. According to the learning behavior data, the current users are categorized into user clusters with similar learning styles in the long-short term memory for self-learning.

This long-short term memory can be learned with the increase of the amount of learning behavior data of users in the database, and the current users can be immediately categorized into corresponding user clusters to carry on subsequent predictions.

The concentration assessment of the long-short term memory:

The long-short term memory is used to judge the current users that belong to the user clusters, and evaluates the concentration indicator according to the distribution of each of the interactive time points on the time axis of the user clusters in the audio-visual knowledge content and the corresponding learning behavior data of each of the interactive time points.

By clustering the current users or the user clusters to which the current users belong, the concentration indicator changes with the corresponding time axis in the audio-visual knowledge content that provides a basis for further predicting the possible interactive behavior generated or adjusting the audio-visual knowledge content for the system administrator.

Concentration prediction and incentive mechanism of the long-short term memory:

The long-short term memory is used to judge the current users that belong to the user clusters, and activates the interactive factors on the user-defined interactive element according to a time interval of lower concentration indicator on the time axis of the user clusters in the audio-visual knowledge content to provide input of the interactive data. By increasing the weight of the interactive factors increases the motivation of users to input interactive data and promote learning behavior data.

By using the long-short term memory to evaluate the user concentration instead of using watch hours as the basis to evaluate the learning effectiveness can predict the time points at which the concentration indicator of current users may decline in the audio-visual knowledge content, and activate the interactive factors at that time points to provide incentives such as rewards, points, etc. Getting interactive feedback and increasing attention from current users can effectively improve the problem of playing learning information on idle computers, so as to enable current users to really watch the content of the audio-visual knowledge content and enhance their interest.

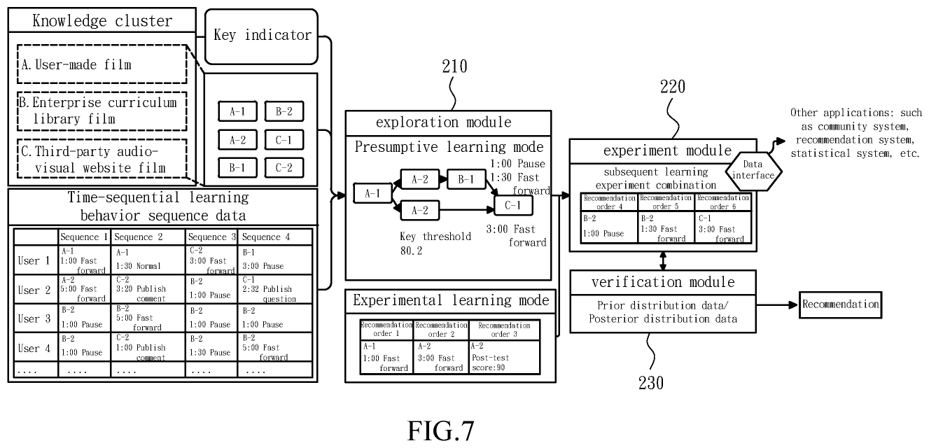

Refer to FIG. 7, which is a system architecture diagram of a recommendation subsystem of the audio-visual teaching platform of the invention. As shown in the figure, the recommendation subsystem of the audio-visual teaching platform of the invention includes exploration module 210, experiment module 220, verification module 230 and optimum practice module, and these modules can be edited in programming languages and stored in electronic devices or storage media devices connected by electronic devices (e.g. network file servers, disk drives or portable disks, etc.).

The exploration module 210 receives various learning behavior data from different users watching plural audio-visual knowledge content from different sources among the same or different users, and generates at least one presumptive learning mode according to at least one of these learning behavior data. The users can be another electronic device, such as personal computers, laptops, tablets, smart phones, etc. with connecting networks (e.g. local area network or Internet).

The exploration module 210 categorizes each of the plural audio-visual knowledge content into at least one knowledge cluster according to its source and learning theme. Furthermore, the exploration module 210 can use existing exploration techniques based on semantic or literary meanings to analyze the text or voice content of each of the plural audio-visual knowledge content, and automatically categorize each of the plural audio-visual knowledge content into different knowledge clusters, or receive the categorization information of the system administrator or user, and categorize each of the plural audio-visual knowledge content into at least one knowledge cluster according to its source and learning theme.

For example, junior high school and elementary school students have knowledge clusters of different disciplines such as Chinese, English, mathematics, etc. Enterprises have knowledge clusters of different education and training disciplines, such as newcomer training, corporate culture, etc. For example, the knowledge cluster named “Insurance” may include the plural audio-visual knowledge content such as long-term care insurance films uploaded by users themselves, accidental insurance films loaded by system administrators in the enterprise curriculum library, fire affairs films uploaded by users from third-party audio-visual websites, car accidents films, etc. Or, the plural audio-visual knowledge content from different sources, such as gender equality, work rights and vacation regulations, can be categorized together as a knowledge cluster named “Labor Rights and Interests”.

Alternatively, the plural audio-visual knowledge content such as English vocabulary, English grammar, English sentence patterns, Japanese vocabulary, Japanese grammar and Japanese sentence patterns can be categorized together as a knowledge cluster named “Foreign Languages Learning”. Otherwise, the plural audio-visual knowledge content such as English vocabulary, English grammar and English sentence patterns can be categorized as a knowledge cluster named “English Learning”, or Japanese vocabulary, Japanese grammar, and Japanese sentence patterns can be categorized as a knowledge cluster named “Japanese Learning”.

From the above, it can be seen that the sources of the plural audio-visual knowledge content can be at least made up of user-made teaching films, teaching films uploaded by system administrators, or films downloaded or linked by audio-visual websites. All knowledge clusters are stored in the database.

Further, the exploration module 210 takes at least one learning behavior or a self-defined operational formula of the user for each of the plural audio-visual knowledge content as a key indicator. The learning behavior can be the test scores after learning, the number of interaction between users and instructors, the number of questions asked, etc. The self-defined operational formula can be described as a combination of any of the above two learning behaviors, or a combination of any of the above two learning behaviors calculated with different weights. For example, the key indicator is that the test scores after learning are above 90 points; or the test scores after learning are above 80 points, and the number of interaction between users and lecturers is more than three times; or the key indicator is that the test scores after learning are above 80 points accounted for 30% of the weight, and the number of interaction between users and lecturers is more than three times accounted for 30% of the weight, and the number of questions asked is more than four times accounted for 40% of the weight.

Furthermore, the exploration module 210 captures the time-sequential learning behavior sequence data of each user in the knowledge cluster, and uses decision tree classification model to distinguish the learning behavior of each user in each knowledge cluster according to each of the key indicators, thus generating learning modes. Finally, calculate an optimum of the key indicators or a key threshold set for each of the learning modes, taking output as at least one presumptive learning mode.

Moreover, the learning behavior refers to an access behavior at each of the time points and an interactive data for each of the plural audio-visual knowledge content when each user watching the plural audio-visual knowledge content from different sources, wherein the access behavior includes normal playback, backward playback, various times of fast playback, pause, etc., while the interactive behavior includes commenting, asking questions, answering questions, taking notes, marking the key points, etc.

The experiment module 220 selects one of the learning modes and one of the knowledge clusters as the experimental learning mode, from which a subsequent learning experiment combination is generated. The subsequent learning experiment combination includes at least one of the audio-visual knowledge content, the learning behavior and a key experimental indicator. In addition, the audio-visual knowledge content of the subsequent learning experiment combination can be the one that the user has watched or has not watched, and the learning behavior can be the same or different from a selected learning mode. The key experimental indicator can be the same or different from the key indicator of the selected learning mode.

Furthermore, the experiment module 220 can open connection interfaces to allow external testing groups to make use of the subsequent learning experiment combination to carry on the experiment. The external testing group can enter the experiment module 220 for the users of a community website to learn. The experiment module 220 judges whether the users of the testing group in the process of experiment have browsed the audio-visual knowledge content and practiced their learning behavior, and whether they have met the requirement of the key experimental indicator. The experiment is successful if the users browse the audio-visual knowledge content of the subsequent learning experiment combination, practice the learning behavior and meet the requirement of the key experimental indicator. Otherwise, the experiment module 220 needs to select the other learning modes of the selected knowledge cluster and repeat the experiment according to the above process until it succeeds.

The verification module 230 selects at least one learning mode to validate whether the subsequent learning experiment combination meets validation requirements. When the verification module 230 validates that the subsequent learning experiment combination meets the requirements, the subsequent learning experiment combination is used as the recommended learning combination. The validation method of the verification module 230 for the subsequent learning experiment combination is to define at least one learning mode accepted by the verification module 230 as prior distribution data, and the learning mode selected by the verification module 230 must be different from the learning mode selected by the experiment module 220, and using this to calculate posterior distribution data. After completing the experiment in the experiment module 220, the distribution distance between the posterior distribution data after random sampling and the time-sequential learning behavior sequence data of the subsequent learning experiment combination is calculated.

The aforementioned distribution distance algorithm is different from the node distance mentioned above. The so-called distribution distance refers to the time-sequential learning behavior sequence data of the actual learning behavior of the subsequent learning experiment combination. When it is similar to the time-sequential learning behavior sequence data of the posterior distribution data, it indicates that the distribution distance is close, otherwise the distance is far. The most commonly used method is KL divergence (Kullback-Leibler Divergence), and the distribution distance is defined as

$$D ( p \vert q ) = \int p ( x ) ln \frac{p ( x )}{q ( x )} dx$$

From the two probability distributions p(x) and q(x) in the above equation formula can be known that when the difference between these two distributions is large, p(x)/q(x) is quite large, and the difference between these two distributions is small, p(x)/q(x) is small. It is defined as whether the similarity between these two distributions meets a validation threshold or not. If it is judged that it meets the validation threshold, the subsequent learning experiment combination is taken as the recommended learning combination.

If it is judged that it does not meet the validation threshold, it is still considered as a failure of the experiment. It is necessary to regenerate a subsequent learning experiment combination, and carry on the experiment and validation once again. Regardless of the validation is successful or not, the invention can reenter the exploration module 210 and the experiment module 220 at any time to recalculate the learning mode, the presumptive learning mode and the subsequent learning experiment combination, and carry on the experiment and validation.

In the present invention, the optimum practice module converts the time-sequential learning behavior sequence data and identity information of users to a series of variables. The optimum practice module takes each of the users as a node to calculate clustering distances between each of the series of variables and uses this as a clustering benchmark, and classifies each of the users who meets the thresholds of different clustering benchmarks into at least one clustering group, or the user whose average distance of one of the clustering distances is the smallest in each of the at least one clustering group is further searched as a group opinion leader of this clustering group.

The user identity information includes the user name, gender, age or name of affiliated unit to which the user belongs, etc. The time-sequential learning behavior sequence data can be the message time, message content and marked object, etc. of the user. The learning behavior of the user can be the operations on the playing way of films, such as pause, rewind, message, and each user has different operations for different types of films. To illustrate how the optimum practice module converts the time-sequential learning behavior sequence data and identity information of the user to a series of variables, the following is illustrated how an employee watches films of knowledge clusters that are categorized as newcomer training:

The employee presses pause at 1:05 of the film playing time without leaving a message. The affiliated unit of the employee is the management department, and the series of variables can be defined as follows:

x1=65, x2=pause, x3=empty, x4=newcomer training, x5=management department; wherein

x1=65, means that there is a learning behavior when the film is played to 1 minute and 5 seconds; x2=pause, means that learning behavior pauses to play the film; x3=empty, means that there is no message content at this time. If there is any message, message content will be filled in.; x4=newcomer training, means that the employee is watching films of knowledge clusters that are categorized as newcomer training; x5=management department, means that the employee is listed in the affiliated unit of the enterprise.

If the employee leaves a message when the film is played to 2 minutes and 12 seconds, the series variables can be defined as follows:

x1=132, x2=message, x3=message content, x4=newcomer training, x5=management department; wherein

x1=132, means that there is a learning behavior when the film is played to 2 minutes and 12 seconds; x2=message, means that learning behavior is a message, x3=message content, means that the message at this time is the message content; x4=newcomer training, means that the employee is watching films of knowledge clusters that are categorized as newcomer training; x5=management department, means that the employee is listed in the affiliated unit of the enterprise.

The above examples are just for illustration, which are not limited in practical application. For example, x4=newcomer training, in addition to representing the knowledge cluster to which the film belongs, a series of variables of the chapters and types of the film can also be added, as well as a series of variables of the ratings after watching by the trainees, to help the optimum practice module to establish the accuracy of clustering.

Moreover, the optimum practice module further uses frequent pattern mining to calculate non-clustered user who is most in line with a browsing recommended learning mode under each of the knowledge clusters, and actively through one of the recommendation, matching, competition mechanisms or any combination of the two or more to make the non-clustered user approach one of the clustering groups.

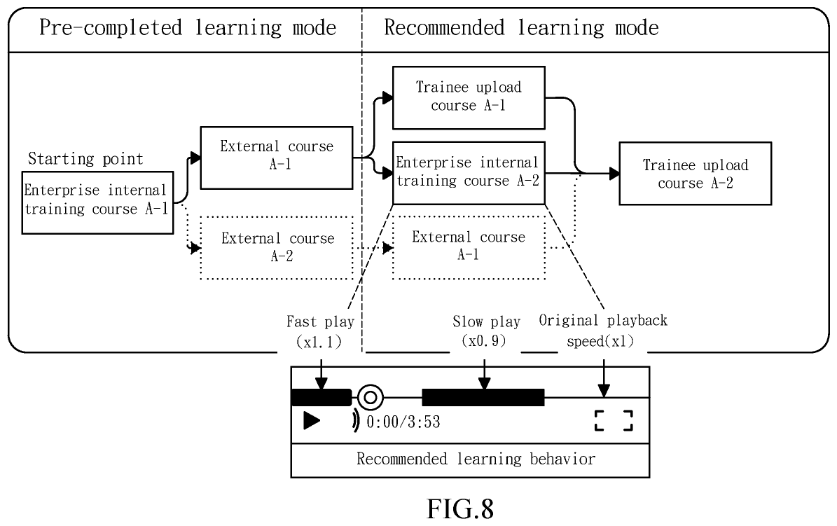

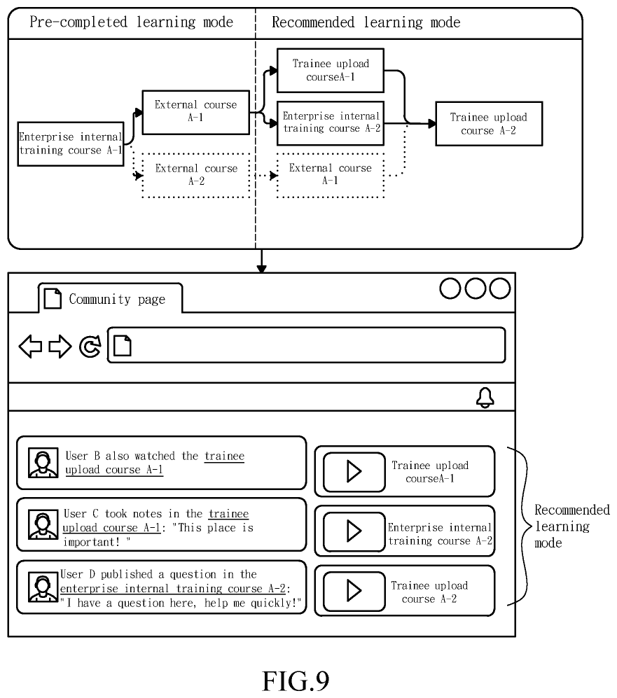

To sum up, please refer to FIGS. 8 and 9, which are schematic diagrams of a recommended learning combination of the invention and a recommendation in FIG. 8, respectively. As shown in the figures, a user A has completed enterprise internal training course A-1, external course A-1 and external course A-2 in advance (that is one of the presumptive learning modes). The recommendation subsystem that utilizes the audio-visual knowledge content of the invention to learn is recommended after experiment and validation through exploration module, experiment module and verification module. The resulting recommended learning mode may be a trainee upload course A-1, enterprise internal training course A-2 and external course A-1. In the recommended learning mode, there are recommended learning behaviors for each course.

Moreover, after selecting the recommended learning mode under each knowledge cluster, if it is to be recommended to a certain group, the group opinion leader will be recommended first, and then let group opinion leader recommend it to other users of the clustering group they belong to, so that users of the same clustering group can have the opportunity to achieve the learning effect as the recommended learning mode. Or it can be directly recommended to the non-clustered users.

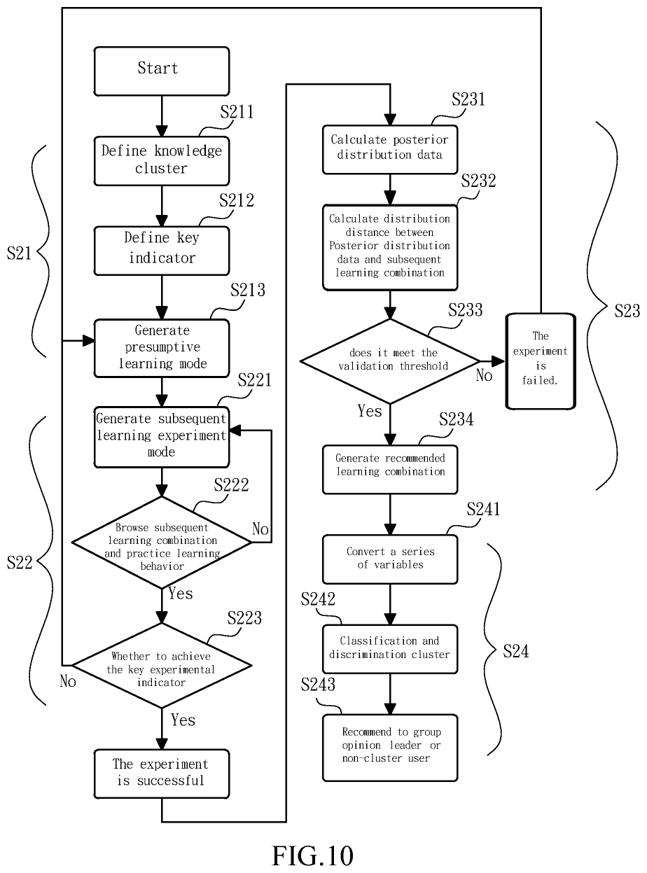

Refer to FIG. 10 for the action flow chart of a recommended method of an audio-visual teaching platform of the invention, which includes the following steps of:

S21: using an exploration module to generate at least one presumptive learning mode according to a learning behavior data of at least one user watching each of plural audio-visual knowledge content from multiple sources; the following steps are also included in this step:

S211: defining knowledge cluster: the exploration module that categorizes each of the plural audio-visual knowledge content into at least one knowledge cluster according to each of multiple sources and a same or similar learning theme; the exploration module can analyze the text or voice content of each of the plural audio-visual knowledge content using existing exploration techniques based on semantic or literary meanings, and automatically categorize each of the plural audio-visual knowledge content into different knowledge clusters, or receive categorization information of the system administrator or user, and categorize each of the plural audio-visual knowledge content into the at least one knowledge cluster according to its source and learning theme.

S212: defining key indicator: the exploration module that takes at least one learning behavior or a self-defined operational formula for each of the plural audio-visual knowledge content as a key indicator; the learning behavior can be the test scores after learning, the number of interaction between users and instructors, the number of questions asked, etc., the self-defined operational formula can be described as a combination of any of the above two learning behaviors, or any combination of the above two learning behaviors under different weights.

S213: generating at least one presumptive learning mode from the exploration module: the exploration module that captures each time-sequential learning behavior sequence data of each user in the knowledge cluster, and using decision tree classification model to distinguish the learning behavior of each user in each knowledge cluster according to each key indicator, thus generating learning modes, and then calculating an optimum of the key indicator or a key threshold set for each of the learning modes, and taking output as the at least one presumptive learning mode.

S22: generating a subsequent learning experiment combination from the experiment module according to the presumptive learning mode; the following steps are also included in this step:

S221: using the experiment module to select one of the learning modes as an experimental learning mode and one of the knowledge clusters, from which the subsequent learning experiment combination is generated; the subsequent learning experiment combination includes at least one of the audio-visual knowledge content, the learning behavior and a key experimental indicator, in addition, the audio-visual knowledge content of the subsequent learning experiment combination can be the one that the user has watched or has not watched, and the learning behavior can be the same or different from a selected learning mode, the key experimental indicator can be the same or different from the key indicator of the selected learning mode.

S222: using the experiment module to judge whether other users have browsed the audio-visual knowledge content of the subsequent learning experiment combination and practiced their learning behavior, if they carry on step S223, otherwise they carry on step S221; other users can open connection interfaces to allow external testing groups to make use of the subsequent learning experiment combination to carry on experiment.

S223: using the experiment module to judge whether the subsequent learning experiment combination meets the requirements of the key experimental indicator, if so, the experiment being successful, otherwise carrying on step S213.

Since it is not clear whether the experiment of the subsequent learning experiment combination which is successful through the experiment module can meet the learning purpose of each knowledge cluster, in order to make the subsequent learning experiment combination more close to the learning purpose of each knowledge cluster, the following steps are carried on after the above step S22:

S23: using the verification module to verify whether the subsequent learning experiment combination meets the validation requirements according to one of the presumptive learning modes, and the learning mode selected by the verification module that must be different from the learning mode selected by the experiment module, when the verification module judges that the subsequent learning experiment combination meets the requirements, the verification module taking the subsequent learning experiment combination as the recommended learning combination, otherwise, the experiment being deemed to have failed and carrying on step S213; the validation method of the verification module for the subsequent learning experiment combination including the following steps of:

S231: defining at least one of the learning modes accepted by the verification module as a prior distribution data and using this to calculate a posterior distribution data;

S232: calculating a distribution distance between the posterior distribution data after random sampling and the time-sequential learning behavior sequence data of the learning behavior in practice of the subsequent learning experiment combination after completing the experiment in the experiment module;

S233: defining as whether a similarity between the above two data meets a validation threshold or not, carrying on step S234 when the similarity meets the validation threshold, otherwise carrying on step S235;

S234: taking the subsequent learning experiment combination as the recommended learning combination;

S235: confirming the experiment to be a failure, carrying on the experiment and validation once again in step S213 by generating a new subsequent learning experiment combination.

In addition, whether the validation is successful or not, the invention can reenter the exploration module and the experiment module at any time to recalculate the learning mode, the presumptive learning mode and the subsequent learning experiment combination, and carry on experiment and validation.

In order to properly recommend the recommended learning combination to other users, in the present invention, after step S23, the following steps are performed:

S24: using the optimum practice module to recommend the recommended learning combination to other users who need the same or similar presumptive learning mode, so that the plural audio-visual knowledge content from multiple sources can be optimized for cohesive learning; the way of the recommended learning combination recommended by the optimum practice module including the following steps of:

S241: using the optimum practice module to convert the time-sequential learning behavior sequence data and knowledge content information of users to a series of variables;

S242: taking each user as a node to calculate clustering distances between the series of variables of each user and using this as a clustering benchmark, and classifying each user who meets thresholds of different clustering benchmarks into at least one clustering group, or the user whose average distance of one of the clustering distances is the smallest in each of the at least one clustering group being further searched as a group opinion leader;

S243: using frequent pattern mining in the optimum practice module to calculate non-clustered user who is most in line with a browsing recommended learning mode under each of the at least one knowledge cluster, and through one of recommendation, matching, competition mechanisms, or any combination of the above two or more to make the non-clustered user approach one of the at least one clustering group.

As mentioned above, the plural audio-visual knowledge content from multiple sources can produce the optimal cohesive learning mode of various learning themes without screening through a lot of manpower. The recommended learning combination can be recommended to other users with the same or similar presumptive learning mode, so that the plural audio-visual knowledge content from multiple sources can be optimized for cohesive learning. Therefore, the invention solves the problem that the traditional audio-visual knowledge content needs a lot of manpower to organize, and is more difficult to connect with the plural audio-visual knowledge content of formal and systematic education and training.

What is claimed is:

1. An audio-visual teaching platform, comprising:
an analysis subsystem generating a learning behavior data of a current user related to each of interactive factors at any one of the interactive time points on a time axis of each of plural audio-visual knowledge content by means of a user clustering data, an image object sequence, an audio sequence, a message sequence and a time-sequential interactive sequence;
a recommendation subsystem being connected with the analysis subsystem, the recommendation subsystem generating at least one presumptive learning mode according to the learning behavior data of the plural audio-visual knowledge content from multiple sources watched by at least one user, and generating a subsequent learning experiment combination according to the at least one presumptive learning mode to validate the subsequent learning experiment combination according to any one of learning modes in the at least one presumptive learning mode, the subsequent learning experiment combination being regarded as a recommended learning combination when the subsequent learning experiment combination meets validation requirements; and
a training subsystem being connected with the recommendation subsystem, the training subsystem setting each of the interactive time points in each of the plural audio-visual knowledge content according to the recommended learning combination, and transmitting each of the interactive time points in each of the plural audio-visual knowledge content to a database, the training subsystem that provides at least one of preset plural audio-visual knowledge content to the at least one user to provide the plural audio-visual knowledge content for the at least one user to watch and learn.

2. The audio-visual teaching platform of claim 1, wherein the analysis subsystem further includes:
an integrated multi-sequence analysis module generating the learning behavior data of the current user related to the interactive factors at any one of the interactive time points on the time axis of the plural audio-visual knowledge content by means of the user clustering data, the image object sequence, the audio sequence, the message sequence and the time-sequential interactive sequence;
a user-defined interactive element being set on an audio-visual knowledge content interface and contains the interactive factors, each of the interactive factors provides input of an interactive data;
a user analysis module using plural historical learning behavior data of all users in a database to calculate a distance and clustering according to each of the plural historical learning behavior data, and categorizes current users into their corresponding user clusters to generate the user clustering data related to clustering results;
an audio-visual content analysis module marking objects in the image data belonging to the plural audio-visual knowledge content to generate the image object sequence related to each of time points in the plural audio-visual knowledge content, carries on an audio frequency analysis of audio data belonging to the plural audio-visual knowledge content, and calculates a pitch of each of audio frames to generate the audio sequence related to each of the time points in the plural audio-visual knowledge content; and
a message analysis module using texts extracted from the database to carry on purpose classification for the interactive data to generate the message sequence related to a purpose of the interactive data.

3. The audio-visual teaching platform of claim 1, wherein the recommendation subsystem includes:
an exploration module generating the at least one presumptive learning mode according to the learning behavior data of the at least one user watching the plural audio-visual knowledge content from multiple sources;
an experiment module being connected with the exploration module to receive the at least one presumptive learning mode and generates the subsequent learning experiment combination according to the at least one presumptive learning mode;
a verification module being connected with the experiment module and the exploration module to receive the at least one presumptive learning mode and the subsequent learning experiment combination, the verification module validates the subsequent learning experiment combination according to any one of the learning modes in the at least one presumptive learning mode, the subsequent learning experiment combination is regarded as the recommended learning combination when the subsequent learning experiment combination meets the validation requirements.

4. The audio-visual teaching platform of claim 1, wherein the training subsystem generates a knowledge map according to the recommended learning combination and transmits the knowledge map to the database.

5. An analysis subsystem of an audio-visual teaching platform, comprising:
an integrated multi-sequence analysis module generating a learning behavior data of a current user related to each of interactive factors at any one of interactive time points on a time axis of each of plural audio-visual knowledge content by means of a user clusteriag data, an image object sequence, an audio sequence, a message sequence and a time-sequential interactive sequence;
a user-defined interactive element being set on an audio-visual knowledge content interface, and containing the interactive factors, each of the interactive factors provides input of an interactive data;
a user analysis module using plural historical learning behavior data of all users in a database to calculate a distance and clustering according to each of the plural historical learning behavior data, and categorizing current users into corresponding user clusters to generate the user clustering data related to clustering results;
an audio-visual content analysis module marking object in the image data belonging to the plural audio-visual knowledge content to generate the image object sequence related to each of time points in the plural audio-visual knowledge content, carrying on an audio frequency analysis of audio data belonging to the plural audio-visual knowledge content, and calculating a pitch of each of audio frames to generate the audio sequence related to each of the time points in the plural audio-visual knowledge content;
a message analysis module using texts extracted from the database to carry on purpose classification for the interactive data to generate the message sequence related to a purpose of the interactive data; and
a time-sequential interactive module correlating an input time of the interactive data and the corresponding time points in the time axis of the plural audio-visual knowledge content and generates the interactive time points, and combining each of the interactive time points in the time axis of the plural audio-visual knowledge content to generate the time-sequential interactive sequence.

6. The analysis subsystem of the audio-visual teaching platform of claim 5, wherein the interactive factors include asking questions, answering questions, taking notes, marking key points, emoticons, fast forward and rewind.

7. The analysis subsystem of the audio-visual teaching platform of claim 5, wherein the user-defined interactive element further sets a weight of the interactive factors, the learning behavior data corresponding to each of user clusters and the interactive factors are generated through a correlation between the integrated multi-sequence analysis module and the user clustering data.

8. An analysis method of an audio-visual teaching platform, comprising:
inputting an interactive data into an interactive factor in a user-defined interactive element set on an audio-visual knowledge content interface;
using user analysis module to calculate a distance and clustering of plural historical learning behavior data of all users in a database according to each of the plural historical learning behavior data, and categorizing current users into corresponding user clusters to generate a user clustering data;
marking object in an image data belonging to an audio-visual knowledge content by an audio-visual content analysis module to generate an image object sequence related to each of time points in the audio-visual knowledge content;
calculating a pitch of each of audio frames of audio data that belongs to the audio-visual knowledge content by the audio-visual content analysis module for audio frequency analysis to generate an audio sequence related to each of the time points in the audio-visual knowledge content;
extracting texts in the database, and carrying on a purpose classification of the interactive data by a message analysis module to generate a message sequence related to a purpose of the interactive data;
taking an input time of the interactive data with each of the corresponding time points in the audio-visual knowledge content to generate each of interactive time points by a time-sequential interactive module, and combining each of the interactive time points in a time axis of the audio-visual knowledge content to generate a time-sequential interactive sequence; and
correlating the user clustering data, the image object sequence, the audio sequence, the message sequence and the time-sequential interactive sequence with the interactive data by an integrated multi-sequence analysis module to generate a learning behavior data at any one of the time points in the audio-visual knowledge content.

9. The analysis method of an audio-visual teaching platform of claim 8, wherein the interactive factor includes asking questions, answering questions, taking notes, marking key points, emoticons, fast forward and rewind.

10. The analysis method of an audio-visual teaching platform of claim 8, wherein a weight of the interactive factor is further set through a correlation between the integrated multi-sequence analysis module and the user clustering data, the learning behavior data corresponding to the user clusters and the interactive factor are generated.

11. The analysis method of an audio-visual teaching platform of claim 8, wherein the time-sequential interactive module collects each of the interactive time points on the time axis of the audio-visual knowledge content and the corresponding learning behavior data to generate a long-short term memory.

12. The analysis method of an audio-visual teaching platform of claim 11, wherein the current users are compared with the long-short term memory, and the current users are categorized into user clusters with similar learning styles in the long-short term memory according to the learning behavior data.

13. The analysis method of an audio-visual teaching platform of claim 12, wherein using the long-short term memory judges the current users that belong to the user clusters, and evaluates the concentration indicator according to a distribution of each of the interactive time points on the time axis of the user clusters in the audio-visual knowledge content and the corresponding learning behavior data of each of the interactive time points.

14. The analysis method of an audio-visual teaching platform of claim 13, wherein the long-short term memory is used to judge the current users that belong to the user clusters, and activates the interactive factors on the user-defined interactive element according to a time interval of low concentration indicator on the time axis of the user clusters in the audio-visual knowledge content to provide input of the interactive data.

15. A recommendation subsystem of an audio-visual teaching platform, comprising:
an exploration module generating at least one presumptive learning mode according to a learning behavior data of at least one user watching plural audio-visual knowledge content from multiple sources;
an experiment module that being connected with the exploration module to receive the at least one presumptive learning mode, and generating a subsequent learning experiment combination according to the at least one presumptive learning mode;
a verification module being connected with the experiment module and the exploration module to receive the at least one presumptive learning mode and the subsequent learning experiment combination, the verification module validating the subsequent learning experiment combination according to any one of learning modes in the at least one presumptive learning mode, when the subsequent learning experiment combination meets the verification requirements, taking the subsequent learning experiment combination as a recommended learning combination.

16. The recommendation subsystem of the audio-visual teaching platform of claim 15, wherein the exploration module categorizes each of the plural audio-visual knowledge content into at least one knowledge cluster according to its source and a related learning theme, and takes one of at least one learning behavior of the at least one user for each of the plural audio-visual knowledge content or a self-defined operational formula or a combination of the above two as a key indicator.

17. The recommendation subsystem of the audio-visual teaching platform of claim 16, wherein the exploration module captures a time-sequential learning behavior sequence data of each of the at least one learning behavior of each of the at least one user in the at least one knowledge cluster, and the exploration module uses decision tree classification model to distinguish the at least one learning behavior of each of the at least one user in each of the at least one knowledge cluster according to the key indicator to generate the learning modes, and calculates an optimum of the key indicator or a key threshold set for each of the learning modes to take output as the at least one presumptive learning mode.

18. The recommendation subsystem of the audio-visual teaching platform of claim 17, wherein the at least one learning behavior refers to an access behavior at each of time points and an interactive data for each of the plural audio-visual knowledge content when each of the at least one user watches each of the plural audio-visual knowledge content.

19. The recommendation subsystem of the audio-visual teaching platform of claim 18, wherein the experiment module selects one of the learning modes and one of the at least one knowledge clusters, from which the subsequent learning experiment combination is generated, the subsequent learning experiment combination includes at least one of the following three parts: the plural audio-visual knowledge content, the at least one learning behavior and a key experimental indicator; the plural audio-visual knowledge content of the subsequent learning experiment combination is the one that the at least one user has watched or has not watched, and each of the at least one learning behavior is the same or different from each of the learning modes selected, the key experimental indicator is the same or different from the key indicator of each of the learning modes selected.

20. The recommendation subsystem of the audio-visual teaching platform of claim 19, wherein the experiment module through connection interface to allow external testing group makes use of the subsequent learning experiment combination to carry on an experiment.

21. The recommendation subsystem of the audio-visual teaching platform of claim 20, wherein the experiment module judges whether the at least one user has browsed each of the plural audio-visual knowledge content of the subsequent learning experiment combination and practiced the at least one learning behavior, and when the requirements of the key experimental indicator are met, the experiment module confirms that the experiment is successful.

22. The recommendation subsystem of the audio-visual teaching platform of claim 21, wherein the experiment module judged that the at least one user has not browsed each of the plural audio-visual knowledge content of the subsequent learning experiment combination or has not practiced the at least one learning behavior, or has not met the key experimental indicator, and the experiment module confirms that the experiment is a failure if any one of the above three conditions exists.

23. The recommendation subsystem of the audio-visual teaching platform of claim 17, wherein the verification module validates that the subsequent learning experiment combination meets one validation requirement according to at least one of the learning modes, the subsequent learning experiment combination is taken as the recommended learning combination.

24. The recommendation subsystem of the audio-visual teaching platform of claim 23, wherein the at least one of the learning modes accepted by the verification module is defined as a prior distribution data and using this to calculate posterior distribution data, the distribution distance between one of the posterior distribution data after random sampling and the time-sequential learning behavior sequence data in the at least one learning mode of the subsequent learning experiment combination is calculated after completing an experiment in the experiment module, which is defined as whether a similarity between the above two data meets a validation threshold or not, the subsequent learning experiment combination is taken as the recommended learning combination when the similarity is judged to meet the validation threshold.

25. The recommendation subsystem of the audio-visual teaching platform of claim 24, wherein the verification model still confirms that the experiment is a failure if the verification module is judged not to meet the validation threshold, another subsequent learning experiment combination is regenerated, and then the experiment and validation procedure are carried on.

26. The recommendation subsystem of the audio-visual teaching platform of claim 17, wherein the recommendation subsystem further includes an optimum practice module which converts the information of the time-sequential learning behavior sequence data of the at least one learning behavior and the plural audio-visual knowledge content of any one of the at least one user to a series of variables, takes each of the at least one user as a node to calculate clustering distances between the series of variables of each of the at least one user and uses this as a clustering benchmark, or the at least one user whose average distance of the clustering distances is the smallest among each clustering group is further searched as a group opinion leader.

27. The recommendation subsystem of the audio-visual teaching platform of claim 26, wherein the optimum practice module uses a frequent pattern mining to calculate non-clustered user who is most in line with a browsing recommended learning mode under each of the at least one knowledge cluster, and actively through one of the recommendation, matching, competition mechanisms to make the non-clustered user approach one of the clustering groups.

28. A recommendation method of an audio-visual teaching platform that is applied to an electronic device wherein the electronic device is performed, including:
using an exploration module to generate at least one presumptive learning mode according to a learning behavior data of at least one user watching each of plural audio-visual knowledge content from multiple sources;
using an experiment module to generate a subsequent learning experiment combination according to the at least one presumptive learning model, when the experiment module judges that the subsequent learning experiment combination meets a requirement of a key experimental indicator, the experiment module confirming an experiment is successful;
using a verification module to validate whether the subsequent learning experiment combination meets a validation requirement according to any one of learning modes; and
taking the subsequent learning experiment combination as a recommended learning combination when the verification module judges that the subsequent learning experiment combination meets the validation requirement.

29. The recommendation method of the audio-visual teaching platform of claim 28, wherein the verification module generates the recommended learning combination, the recommended learning combination is recommended by an optimum practice module to the at least one user who needs the at least one presumptive learning mode.

30. The recommendation method of the audio-visual teaching platform of claim 28, wherein a process by which the exploration module generates the at least one presumptive learning model includes:
defining knowledge cluster: the exploration module that categorizes each of the plural audio-visual knowledge content into the at least one knowledge cluster according to each of multiple sources and a same or similar learning theme;
defining key indicator: the exploration module that takes one of at least one learning behavior or a self-defined operational formula or a combination of the above two for each of the plural audio-visual knowledge content of the at least one user as the key indicator; and
generating the at least one presumptive learning mode from the exploration module: the exploration module that captures a time-sequential learning behavior sequence data of each of the at least one learning behavior of each of the at least one user in the at least one knowledge cluster, and using a decision tree classification model to distinguish the at least one learning behavior of each of the at least one user in the at least one knowledge cluster according to the key indicator to generate the learning modes to calculate an optimum of the key indicator or a key threshold set of each of the learning modes and to take output as the at least one presumptive learning mode.

31. The recommendation method of the audio-visual teaching platform of claim 30, wherein the steps by which the experiment module generates the subsequent learning experiment combination according to the at least one presumptive learning mode further include:
using the experiment module to select one of the learning modes as an experimental learning mode and one of the at least one knowledge cluster, from which the subsequent learning experiment combination is generated;
using the experiment module to judge whether the at least one user has browsed each of the plural audio-visual knowledge content of the subsequent learning experiment combination and practiced the at least one learning behavior;
judging whether the experiment module meets the requirement of the key experimental indicator when the at least one user has browsed each of the plural audio-visual knowledge content of the subsequent learning experiment combination and practiced the at least one learning behavior;
confirming the experiment to be successful when the experiment module is judged to meet the requirement of the key experimental indicator;
regenerating another presumptive learning model when the experiment module judges that the at least one user has not browsed each of the plural audio-visual knowledge content of the subsequent learning experiment combination or has not practiced one of the at least one learning behavior or has not met the requirement of the key experimental indicator.

32. The recommendation method of the audio-visual teaching platform of claim 31, wherein a validation method of the verification module for the subsequent learning experiment combination includes:
defining at least one of the learning modes accepted by the verification module as a prior distribution data and using this to calculate a posterior distribution data;
calculating a distribution distance between the posterior distribution data after random sampling and the time-sequential learning behavior sequence data of the at least one learning behavior in practice of the subsequent learning experiment combination after completing the experiment in the experiment module;
defining as whether a similarity between the above two data meets a validation threshold or not;
taking the subsequent learning experiment combination as the recommended learning combination when the similarity meets the validation threshold;
confirming the experiment to be a failure when the similarity does not meet the validation threshold, and regenerating a new subsequent learning experiment combination for further experiment and validation.

33. The recommendation method of the audio-visual teaching platform of claim 29, wherein the optimum practice module includes:
converting the information of the time-sequential learning behavior sequence data of the at least one learning behavior of the at least one user and identity information of the at least one user to a series of variables;
taking each of the at least one user as a node and using the series of variables to calculate clustering distances between each of the at least one user and using this as a clustering benchmark, and classifying each of the at least one user who meets thresholds of different clustering benchmarks into at least one clustering group, or the at least one user whose average distance of one of the clustering distances is the smallest in each of the at least one clustering group being further searched as a group opinion leader;
using frequent pattern mining to calculate non-clustered user who is most in line with a browsing recommended learning mode under each of the at least one knowledge cluster, and through one of recommendation, matching, competition mechanisms, or any combination of the above two or more to make the non-clustered user approach one of the at least one clustering group.
